(19) United States
(12) Patent Application Publication
(10) Pub. No.: US 2016/0098168 A1
(43) Pub. Date: Apr. 7, 2016

(54) METHOD FOR DISPLAYING AND MANAGING INTERACTION SYMBOLS AND ASSOCIATED VIEWING DEVICE WITH A TOUCH SURFACE

(71) Applicant: THALES, Courbevoie (FR)

(72) Inventors: Stephanie LAFON, Merignac (FR); Sylvain HOURLIER, Bordeaux (FR); Emilie DARRIN, St Medard en Jalles (FR)

(21) Appl. No.: 14/874,354

(22) Filed: Oct. 2, 2015

(30) Foreign Application Priority Data
Oct. 3, 2014 (FR) 1402243

(51) Int. Cl. G06F 3/0488; G06F 3/0484; G06F 3/0481

(52) U.S. Cl. CPC G06F 3/0488; G06F 3/04817; G06F 3/0484

(57) ABSTRACT

The general field of the invention is that of methods for managing interaction symbols in a viewing system including an associated viewing device comprising a touch surface and displaying, managing and controlling means. The method according to the invention is implemented so as to manage graphical interactors allowing the functions of a discrete or continuous-state rotary control knob to be carried out. It comprises the following steps:
Step 1: in the absence of tactile stress, displaying a symbol representative of the current state of said rotary control knob;
Step 2: on a first tactile stress, causing interaction icons dedicated to said rotary control knob and surrounding said symbol to appear;
Step 3: by maintaining and moving the tactile stress over the various interaction icons, changing the current state of said rotary control knob; and
Step 4: by stopping the tactile stress, validating the new current state and causing the interaction icons to disappear.

The field of the invention is that of the presentation and management of what are referred to as tactile human-system interactions or HSIs in aircraft cockpits.

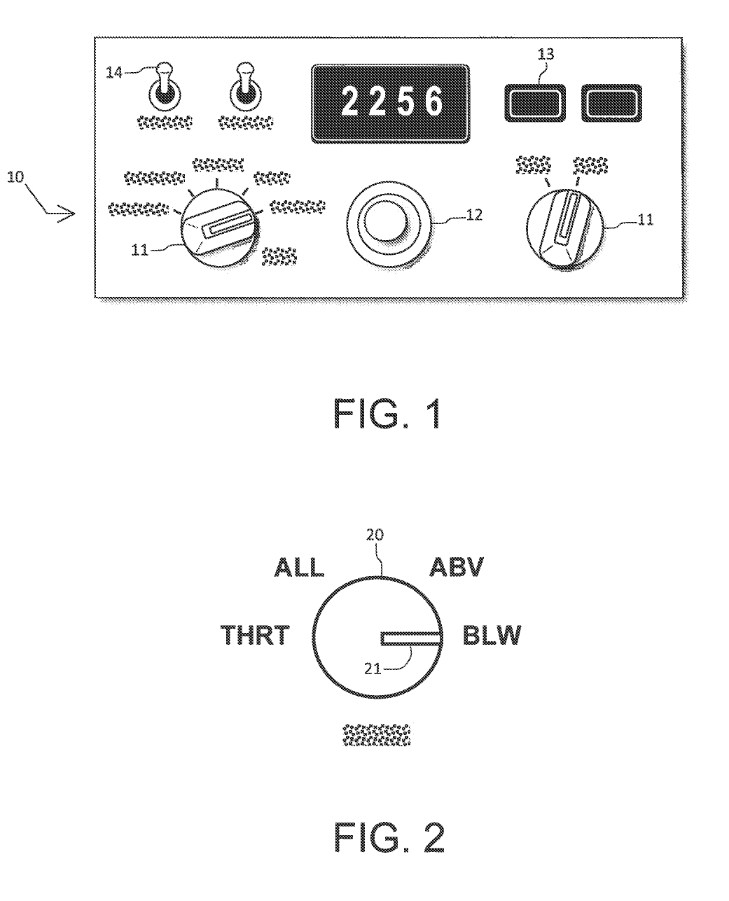

Currently, conventional interaction means in an aircraft cockpit are, in most applications, mechanical interactors. Thus, FIG. 1 shows a control station 10 according to the prior art comprising:
finite-state rotary control knobs 11 having a limited number of positions;
continuous rotary control knobs 12 allowing a parameter such as, for example, a volume level, to be regulated;
possibly mutually exclusive toggle buttons 13 optionally providing visual feedback; and
toggle switches 14 for turning functions on or off.

These conventional means are gradually being replaced by virtual interactor displayed on viewing devices comprising touch surfaces and that carry out the same functions. This solution has many advantages in terms of cost, bulk, flexibility and reconfiguration. However, these tactile interactors must meet a certain number of recommendations specific to the world of aeronautics. In particular, they must:
provide an ergonomic graphical representation. The latter may be similar to that of conventional buttons as shown in the various figures. However, it is possible to use different graphical representations adapted both to the function and to tactile manipulation;
provide an informational display that is fit for purpose, readable and not very space consuming;
provide intuitive and effective interaction modes and make bond adjustment of values possible;
allow critical tactile interactions to be fool-proofed; and
make effective interaction possible even under degraded meteorological conditions, i.e. in the case of turbulence.

Solutions have been proposed to address this problem. Mention may, in particular, be made of the publication US 2013/0249814 entitled “Adjustment mechanisms for virtual knobs on a touchscreen interface”, which describes the principle of a tactile interface intended to replace a physical rotary control knob in the following way. The “push/pull” function making it possible to pass from one mode to another is replaced by prolonged “clicks” on a graphical representation of the physical rotary control knob. On a single click by the user, the screen displays an interactive ring about the virtual rotary control knob. This interactive ring makes a circular interaction in a clockwise or anticlockwise direction possible, allowing a parameter associated with the rotary control knob to be incremented or decremented. The drawbacks of this solution are the following:
the graphical representation is sizeable and poorly suited to placement on the edge of a viewing screen;
a rotary movement is preserved in order for the interaction to remain similar to the existing interaction. However, this type of movement over a touch panel is neither very ergonomic nor very effective;
the rotary control knob is not suitable for selecting between a finite number of states;
the interaction is poorly suited to use under turbulent conditions; and
the adjustment level is fixed.

The method for displaying and managing interaction symbols according to the invention does not have these drawbacks.

It is essentially intended for aircraft flight decks but may also apply to other technical fields, In this aeronautic context, it allows every type of physical interactor present in an aircraft to be replaced. It decreases the amount of training and practice required to master the human/system interface, preferably by providing graphical representations similar to the physical interactors known to pilots. Thus reading and recognition of information is greatly facilitated.

The virtual interactors according to the invention are also fool-proof and meet operational aeronautical requirements. They allow the level of precision of a numerical value selection to be controlled. The gestures to be carried out to change state are simple, effective and adapted to the use of a touch panel. These novel interactors also provide additional functionalities relative to physical interactors, such as the selection of states from a plurality of hierarchical levels. They are more specifically dedicated to the simulation of rotary control knobs.

More precisely, one subject of the invention is a method for displaying and managing interaction symbols in a viewing system including at least one associated viewing device comprising a touch surface and displaying, managing and controlling means, said method, when implemented so as to manage at least one graphical interactor, allowing at least the functions of a rotary control knob to be carried out, characterized in that said displaying and managing method comprises at least the following steps:
Step 1: in the absence of tactile stress, displaying a symbol representative of the current state of said rotary control knob;
Step 2: on a first tactile stress, causing interaction icons dedicated to said rotary control knob and surrounding said symbol to appear;
Step 3; by maintaining and moving the tactile stress over the various interaction icons, changing the current state of said rotary control knob; and
Step 4: by stopping the tactile stress, validating the new current state and causing the interaction icons to disappear.

Advantageously, said rotary control knob being a finite-state rotary control knob, the method comprises the following steps:
Step 1: in the absence of tactile stress, the symbol is surrounded by a plurality of indications representing the various possible states, said indications being placed substantially on a first circular arc surrounding said symbol, said symbol comprising a marker designating a first indication representing a first state, said display being referred to as the current display;
Step 2: on a first tactile stress, replacing the indications with icons representing the various possible states, said icons being placed substantially on a second circular arc surrounding said symbol and of larger radius than the first circular arc and causing a halo to appear in the location of the tactile stress;
Step 3; by maintaining and moving the tactile stress, moving the halo from one icon to the next until the icon representative of a selected second state is reached; and
Step 4: by stopping the tactile stress, selecting said second state and returning to the current display, the marker being positioned on the selected second state.

Advantageously, step 3 is followed by a step 3b is in which at least the selection of a particular icon representing a particular state leads to secondary icons appearing surrounding said icon, each of said secondary icons representing various secondary states associated with said particular state.

Advantageously, said rotary control knob being a continuous-state rotary control knob, the method comprises the following steps:
Step 1: in the absence of tactile stress, the displayed symbol is representative of a value referred to as the current value;
Step 2: on a first tactile stress, two icons of elongate shape appear placed symmetrically on either side of the symbol along an axis, the first icon comprising a “+” sign and the second icon comprising a “−” sign:
Step 3: by maintaining and moving the tactile stress in a direction substantially parallel to said axis, increasing or decreasing the current value to a given value; and
Step 4: by stopping the tactile stress, selecting said given value and returning to the current display.

Advantageously, the further the stress gets from the centre of the axis corresponding to the centre of the symbol, the more rapid the increase or decrease in the current value.

Advantageously, step 4 is followed by a fool-proofing step Obis comprising a brief tactile stress referred to as a “tap”.

Advantageously, the touch surface comprises haptic means.

Advantageously, the symbol is circular in shape and its graphical appearance is that of a mechanical rotary control knob.

The invention also relates to a viewing system including at least one associated viewing device comprising a touch surface and displaying, managing and controlling means, said viewing system comprising electronic and digital means for implementing a method for managing graphical interactors allowing at least the functions of a rotary control knob to be carried out, characterized in that said displaying and managing method comprises the following steps:
Step 1: in the absence of tactile stress, displaying a symbol representative of the current state of said rotary control knob;
Step 2: on a first tactile stress, causing interaction icons dedicated to said rotary control knob and surrounding said symbol to appear;
Step 3: by maintaining and moving the tactile stress over the various interaction icons, changing the current state of said rotary control knob; and
Step 4: by stopping the tactile stress, validating the new current state and causing the interaction icons to disappear.

The invention will be better understood, and other advantages will become apparent, on reading the following description, given by way of nonlimiting example, and from the appended figures in which:

FIG. 1 described above shows a control station according to the prior art;

FIGS. 2, 3, 4 and 5 show the various steps of the method according to the invention in the case of simulation of a finite-state rotary control knob;

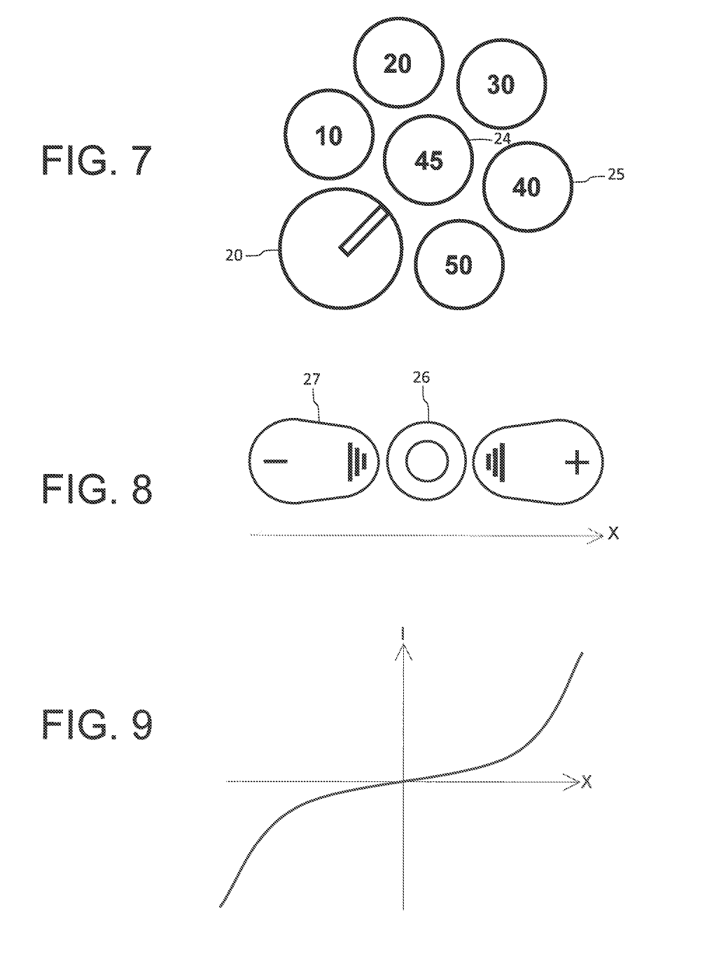

FIGS. 6 and 7 show variant embodiments of the preceding finite-state rotary control knob;

FIG. 8 shows a continuous-state rotary control knob according to the invention; and

FIG. 9 shows the variation in a value represented by the preceding continuous-state rotary control knob as a function of the distance of the stress.

The method for displaying and managing interaction symbols according to the invention is implemented in a viewing system including an associated viewing device comprising a touch surface and displaying, managing and controlling means. Generally, the viewing device is a liquid-crystal viewing device but, of course, the method may be adapted to other types of display. Various types of touch panel are known. Mention may be made, by way of example, of resistive or capacitive touch panels. The graphical managing means are suitable for implementing the various steps of the method.

The displaying and managing method according to the invention is most particularly applied to carry out the same functions as mechanical rotary control knobs. R comprises the following steps:
Step 1: in the absence of tactile stress, displaying a symbol representative of the current state of said rotary control knob;
Step 2: on a first tactile stress, causing interaction icons dedicated to said rotary control knob and surrounding said symbol to appear;
Step 3: by maintaining and moving the tactile stress over the various interaction icons, changing the current state of said rotary control knob; and
Step 4: by stopping the tactile stress, validating the new current state and causing the interaction icons to disappear.

This method may be applied to simulate finite-state rotary control knobs or continuous-state rotary control knobs. By way of nonlimiting example, FIGS. 2, 3, 4 and 5 show the various steps of the method according to the invention in the case of simulation of a finite-state rotary control knob. In these figures, the rotary control knob has four states denoted “THRT”, “ALL”, “ABV” and “BLV”. The number of states may be different.

In a first step 1 shown in FIG. 2, in the absence of tactile stress, a symbol 20 representative of the rotary control knob is displayed. It is a circle in this figure. Of course, the symbol may comprise various shapes, colours and shadows so as to make it resemble a conventional mechanical rotary control knob. It is surrounded by four indications representing the various possible states, denoted “THRT”, “ALL”, “ABV” and “BLVV”. These indications are placed substantially on a first circular arc surrounding the symbol 20. This symbol comprises a marker 21 designating a first indication representing a first state, said display being referred to as the current display. In the case in FIG. 2, this marker is an elongate rectangle and is designating the state “BLW”. It may take another form such as, for example, an arrowhead.

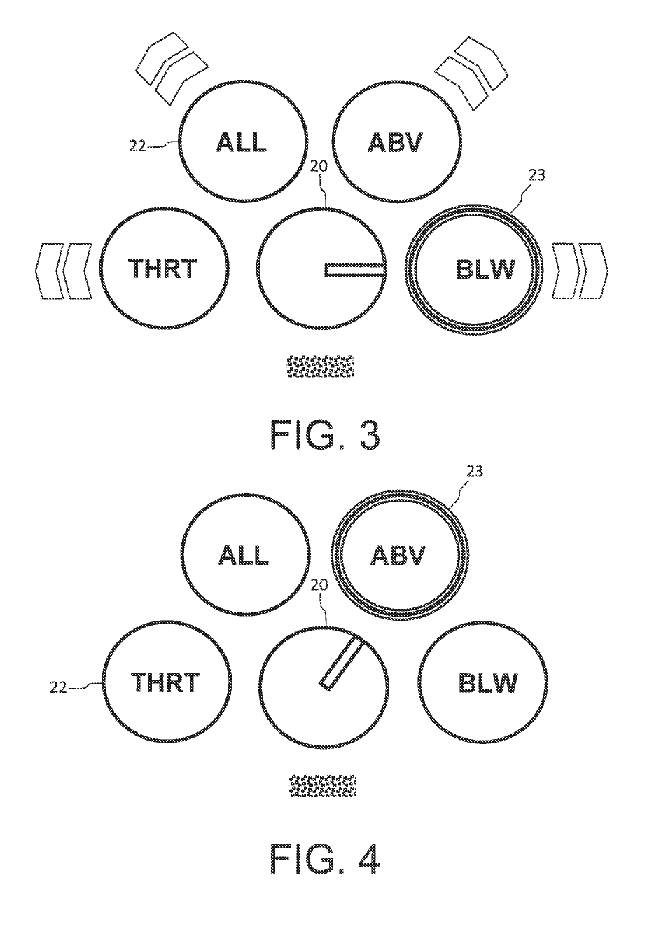

In a second step shown in FIG. 3, on a first tactile stress that corresponds to the finger of a user being pressed against the touch surface in the location of the displayed symbol, the preceding indications are replaced by icons 22 representing the various possible states, these icons being placed substantially on a second circular arc surrounding said symbol and of larger radius than the first circular arc. In FIG. 3, the icons 22 are circles surrounding the states denoted “THRT”, “ALL”, “ABV” and “BLW”. Here again, various shapes, colours and shadows are possible. It is important for these icons to have a certain width, greater than one centimetre, so as to make possible an interaction not requiring a high level of positional precision on the part of the user.

Symbolically, the separation of the icons is represented by the double chevrons in FIG. 3. A halo 23 appears round one of the icons. It is represented by a triple circle in FIGS. 3 and 4. Other graphical representations are possible. At this stage, it is possible to add a delay so that the method does not pass immediately into an interactive state-selecting mode,

In a third step shown in FIG. 4, the halo is maintained and moved, via a tactile stress, to the icon representative of a second state that it is desired to select. In the case in FIG. 4, it is a question of the state “ABV”.

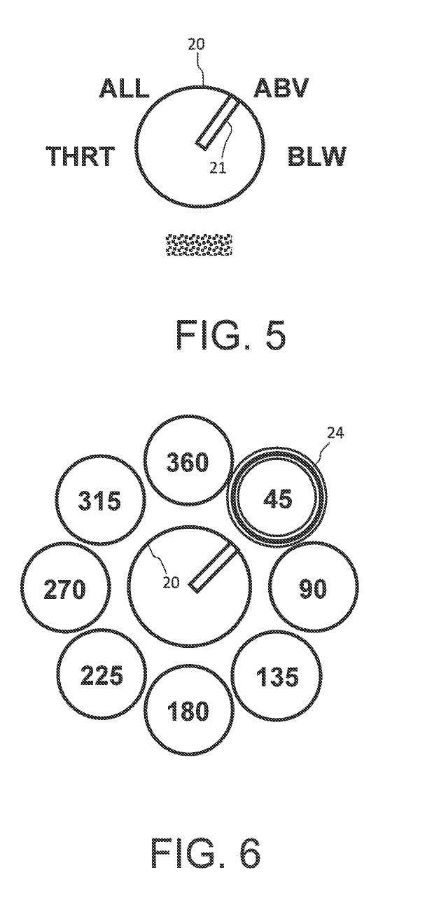

In a fourth and last step shown in FIG. 5, the tactile stress is stopped. The second state is selected. The display returns to the current display, the marker being positioned on the selected second state, In the present case, it is a question of the state “ABV”.

It will be noted that interactions according to the invention are fool-proof, Specifically, a single “tap” cannot modify the state of the interactor. As the user might unintentionally remove his finger, the validation may be fool-proofed by way of a double “tap” or a “tap” with a second finger, in the case of what are referred to as “multitouch” touch screens allowing interaction with more than one finger.

This type of rotary control knob may be used to select a value, By way of example, FIG. 6 shows the selection of a value comprised between 0 and 360 in increments of 45. The symbol 20 is surrounded by 8 icons 24 marked from 45 in steps of 45, Once a value has been selected, it is then possible to refine it by other means. In FIG. 6, the value “45” is selected.

It is also possible to incorporate additional functions that are impossible to reproduce with a physical interactor. Thus, from a selected state, it is possible to access a hierarchical tree of substates. In order to pass from a state to the corresponding substates, the user for example applies a prolonged press or a “tap” or a “double tap” or a “slide” with another finger. The term “slide” is understood to mean the operation that consists In sliding a finger over the touch surface over a certain distance. The objective is not to remove the finger before the end of the interaction. By way of example, in FIG. 7, the choice of the value “45” causes other values arranged in icons 25 comprised between 10 and 50 to appear. It is possible to easily navigate the tree. The tree is collapsed simply by pressing on the original icon.

The method according to the invention also allows a continuous-state rotary control knob, i.e. a rotary control knob allowing a value to be finely adjusted, to be simulated. By way of example, it is thus possible to adjust the value of a radio-frequency or a volume level or even a zoom ratio of a cartographic representation. In this case, the method comprises the following steps:
Step 1: in the absence of tactile stress, the displayed symbol is representative of a value referred to as the current value;
Step 2: on a first tactile stress, two icons of elongate shape appear placed symmetrically on either side of the symbol along an axis, the first icon comprising a “+” sign and the second icon comprising a “−” sign; By way of example, FIG. 8 shows the central symbol 26 surrounded by these two icons 27. The axis is denoted x in FIG. 8;
Step 3: by maintaining and moving the tactile stress along said axis, increasing or decreasing the current value to a given value; and
Step 4: by stopping the tactile stress, selecting said given value and returning to the current display.

The orientation of the axis x is preferably chosen depending on the associated graphical feedback. For example, a level will be adjusted along a vertical axis whereas the axis of a cursor will be horizontal.

The icons may have a certain length, greater than one centimetre, so as to make possible an interaction not requiring a high level of positional precision on the part of the user. It is also possible to perform the interaction “blind”, outside of the zone of the icons, provided that the interaction occurs in the same direction as the axis x. Specifically, the modification of the value of the parameter is generally accompanied by a perceptible effect such as a change in luminosity or a change in the volume of a sound. Is therefore not necessary for the user to precisely control the interaction in so far as he immediately perceives the effects thereof.

The value may be incremented linearly. However, it is preferable for the speed of variation to increase as a function of the distance from the centre of the axis x. The further the stress gets from the centre of the axis corresponding to the centre of the symbol, the more rapid the increase or decrease in the current value. During turbulence, it is important to have an acceleration of the quadratic type in order to prevent variations in speed that are too large when making fine adjustments. This point is illustrated in FIG. 9 which shows the variation of the incrementation speed “I” as a function of the distance from the centre of the axis x. It is low at the centre and high at the ends,

To make it easier to carry out these interactions blind, it is possible, if the viewing device allows it, to add a haptic effect at the boundaries of the zone of interaction in order to prevent unintentional departure therefrom and to allow the user to determine intuitively how far his finger is from the centre.

The advantages of the method for displaying and managing interaction symbols according to the invention are mainly:
It makes teethe interactions fool-proof;
it limits additional training/practice time;
it makes the interactions ergonomical and effective; and
it makes it easy to adapt tactile interactors to any operational requirement.

1. Method for displaying and managing interaction symbols in a viewing system including at least one associated viewing device comprising a touch surface and displaying, managing and controlling means, said method, when implemented so as to manage at least one graphical interactor, allowing at least the functions of a rotary control knob to be carried out, wherein said displaying and managing method comprises at least the following operations:
operation 1: in the absence of tactile stress, displaying a symbol representative of the current state of said rotary control knob;
operation 2: on a first tactile stress, causing interaction icons dedicated to said rotary control knob and surrounding said symbol to appear;
operation: by maintaining and moving the tactile stress over the various interaction icons, changing the current state of said rotary control knob; and
operation 4: by stopping the tactile stress, validating the new current state and causing the interaction icons to disappear.

2. Method for displaying and managing interaction symbols according to claim 1, wherein said rotary control knob being a finite-state rotary control
knob, the method comprises the following operations:
operation 1: in the absence of tactile stress, the symbol is surrounded by a plurality of indications representing the various possible states, said indications being placed substantially on a first circular arc surrounding said symbol, said symbol comprising a marker designating a first indication representing a first state, said display being referred to as the current display;
operation 2: on a first tactile stress, replacing the indications with icons representing the various possible states, said icons being placed substantially on a second circular arc surrounding said symbol and of larger radius than the first circular arc and causing a halo to appear in the location of the tactile stress;
operation 3: by maintaining and moving the tactile stress, moving the halo from one icon to the next until the icon representative of a selected second state is reached; and
operation: by stopping the tactile stress, selecting said second state and returning to the current display, the marker being positioned on the selected second state.

3. Method for displaying and managing interaction symbols according to claim 2, wherein operation 3 is followed by a operation 3b is in which at least the selection of a particular icon representing a particular state leads to secondary icons appearing surrounding said icon, each of said secondary icons representing various secondary states associated with said particular state.

4. Method for displaying and managing interaction symbols according to claim 1, wherein said rotary control knob being a continuous-state rotary control knob, the method comprises the following operations:
operation 1: in the absence of tactile stress, the displayed symbol is representative of a value referred to as the current value;
operation 2: on a first tactile stress, two icons of elongate shape appear placed symmetrically on either side of the symbol along an axis, the first icon comprising a “+” sign and the second icon comprising a “−” sign;
operation 3: by maintaining and moving the tactile stress in a direction substantially parallel to said axis, increasing or decreasing the current value to a given value; and
operation 4: by stopping the tactile stress, selecting said given value and returning to the current display.

5. Method for displaying and managing interaction symbols according to claim 4, wherein, the further the stress gets from the centre of the axis corresponding to the centre of the symbol, the more rapid the increase or decrease in the current value.

6. Method for displaying and managing interaction symbols according to claim 1, wherein operation 4 is followed by a fool-proofing operation 4b is comprising a brief tactile stress referred to as a “tap”.

7. Method for displaying and managing interaction symbols according to claim 1, wherein the touch surface comprises haptic means.

8. Method for displaying and managing interaction symbols according to claim 1, wherein the symbol is of circular shape and its graphical appearance is that of a mechanical rotary control knob.

9. Viewing system including at least one associated viewing device comprising a touch surface and displaying, managing and controlling means, said viewing system comprising electronic and digital means for implementing a method for managing graphical interactors allowing at least the functions of a rotary control knob to be carried out, wherein said displaying and managing method comprises the following operations:
operation 1: in the absence of tactile stress, displaying a symbol representative of the current state of said rotary control knob;
operation 2: on a first tactile stress, causing interaction icons dedicated to said rotary control knob and surrounding said symbol to appear;
operation 3: by maintaining and moving the tactile stress over the various interaction icons, changing the current state of said rotary control knob; and
operation 4: by stopping the tactile stress, validating the new current state and causing the interaction icons to disappear.
